(19) United States
(12) Patent Application Publication
(10) Pub. No.: US 2012/0087636 A1
(43) Pub. Date: Apr. 12, 2012

(54) MOVING IMAGE PLAYBACK APPARATUS, MOVING IMAGE MANAGEMENT APPARATUS, METHOD, AND STORAGE MEDIUM FOR CONTROLLING THE SAME

(75) Inventor: Toshimichi Kudo, Yokohama-shi (JP)

(73) Assignee: CANON KABUSHIKI KAISHA, Tokyo (JP)

(21) Appl. No.: 13/237,040

(22) Filed: Sep. 20, 2011

(30) Foreign Application Priority Data
Oct. 7, 2010 (JP) 2010-227747

(51) Int. Cl. H04N 9/80

(52) U.S. Cl. 386/241; 386/E05.002

(57) ABSTRACT

A moving image playback apparatus includes an acquisition unit configured to acquire main object information, which is usable to identify a frame image in which an object determined as a main object has appeared, from a moving image. The apparatus includes an extraction unit configured to extract, based on the acquired main object information, frame images in which the main object is present from sequential sections in which the object determined as the main object is the same and the main object is continuously present in the moving image. The apparatus further includes a display control unit configured to perform control to arrange and display, in order of time, a plurality of frame images extracted by the extraction unit.

### BACKGROUND OF THE INVENTION

1. Field of the Invention

Embodiments of the present invention relate to a moving image playback apparatus, a moving image management apparatus, a method, and storage medium for controlling these apparatuses. Embodiments of the present invention relate to a display control technique capable of improving the searchability of a desired scene in a moving image.

2. Description of the Related Art

Various types of graphical user interfaces (GUIs) have been conventionally proposed to improve the operability of each apparatus. An information processing apparatus discussed in Japanese Patent Application Laid-Open No. 2008-017041 includes a control unit that can control the display of each GUI. The control unit of the information processing apparatus discussed in Japanese Patent Application Laid-Open No. 2008-017041 can control the display of a first GUI image that includes an index about each one of image contents.

Then, if one index of the first GUI image is selected by a user, the control unit performs control for displaying a second GUI image that includes a face thumbnail image corresponding to the face of a person detected from the corresponding image content. Further, an imaging apparatus discussed in Japanese Patent Application Laid-Open No. 2008-017041 can detect a face from a captured image and set a weighting factor to each face to detect a main object.

However, according to the GUI discussed in Japanese Patent Application Laid-Open No. 2008-017041, if the imaging apparatus performs a face thumbnail image display for a moving image including a scene in which many persons appear simultaneously (e.g., a moving image of a sports meeting), the amount of face information to be processed may become excessively great.

However, it is usual that each user does not want all of the face information in the face thumbnail image display. For example, a main object that the user wants to capture may be surrounded by many other persons. In such a situation, if the face thumbnail image display is performed using all of the face information, the searchability of the main object may deteriorate.

### SUMMARY OF THE INVENTION

Exemplary embodiments of the present invention are directed to improving the searchability of a scene that includes a target object even in a case where many different objects appear simultaneously in a scene of a moving image.

According to an aspect of the embodiments, a moving image playback apparatus includes an acquisition unit configured to acquire main object information, which is usable to identify a frame image in which an object determined as a main object has appeared, from a moving image, an extraction unit configured to extract, based on the acquired main object information, frame images in which the main object is present from sequential sections in which the object determined as the main object is the same and the main object is continuously present in the moving image, and a display control unit configured to perform control to arrange and display, in order of time, a plurality of frame images extracted by the extraction unit.

According to an exemplary embodiment of the present invention, only the frame images in which a main object has appeared are arranged and displayed side by side. Therefore, even in a case where many different objects appear simultaneously in a scene of a moving image, it is feasible to extract each frame in which the main object has appeared and display the arranged images of the extracted frames side by side. Thus, the searchability of the scene including the main object may be improved. In other words, according to an exemplary embodiment of the present invention, users may easily find frame images of a target scene because frame images of an unnecessary scene are not displayed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example configuration of an imaging apparatus to which a moving image playback apparatus and a moving image management apparatus according to an exemplary embodiment of the present invention may be applied.

FIGS. 2A and 2B illustrate an example functional configuration of the moving image playback apparatus and the moving image management apparatus according to an exemplary embodiment of the present invention.

FIGS. 3A and 3B illustrate examples of the display that may be realized by a liquid crystal panel in a shooting operation.

FIG. 4 illustrates an example data configuration of face detection information to be recorded.

FIG. 5 illustrates an example of the face detection information to be recorded, which changes during a shooting operation.

FIG. 6 illustrates an example of management information.

FIG. 7 is a flowchart illustrating an example of constructive processing of face index information according to an exemplary embodiment of the present invention.

FIG. 8 illustrates an example of constructed face index information.

FIG. 9 illustrates an example of the time line display.

FIG. 10 illustrates an example list of designation intervals selectable for the time line display.

FIG. 11 illustrates an example of a face time line display.

FIG. 12 illustrates an example of a main face time line display.

FIG. 13 is a flowchart illustrating an example of time line display processing according to an exemplary embodiment of the present invention.

### DESCRIPTION OF THE EMBODIMENTS

Various exemplary embodiments, features, and aspects of the invention will be described in detail below with reference to the drawings.

One disclosed feature of the embodiments may be described as a process which is usually depicted as a flowchart, a flow diagram, a timing diagram, a structure diagram, or a block diagram. Although a flowchart or a timing diagram may describe the operations or events as a sequential process, the operations may be performed, or the events may occur, in parallel or concurrently. In addition, the order of the operations or events may be re-arranged. A process is terminated when its operations are completed. A process may correspond to a method, a program, a procedure, a method of manufacturing or fabrication, a sequence of operations performed by an apparatus, a machine, or a logic circuit, etc.

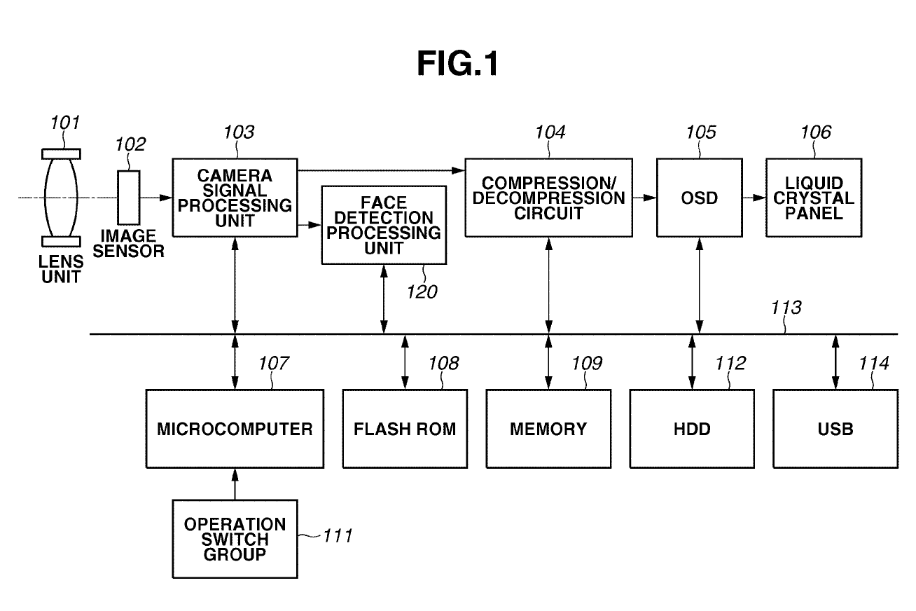

FIG. 1 is a block diagram illustrating an example configuration of an imaging apparatus (e.g., a digital video camera) to which a moving image playback apparatus and a moving image management apparatus according to an exemplary embodiment of the present invention may be applied. The imaging apparatus illustrated in FIG. 1 includes a lens unit 101, an image sensor 102, a liquid crystal panel 106, and an operation switch group 111.

The imaging apparatus further includes a camera signal processing unit 103, a compression/decompression circuit 104, an on-screen display (OSD) unit 105, a microcomputer 107, a flash read only memory (ROM) 108, a memory 109, a hard disk (HDD) 112, a universal serial bus (USB) device 114, and a face detection processing unit 120, which are connected via a bus 113 to communicate with each other.

The lens unit 101 includes a beam-condensing stationary lens group, a variator lens group, a diaphragm, and a compensator lens group. The compensator lens group is functionally operable to compensate for an image-forming position that has moved according to a movement of the variator lens group. Furthermore, the compensator lens group has the capability of performing a focus adjustment operation.

The lens unit 101 may form an object image on an image-formation surface of the image sensor 102. The image sensor 102 may convert light into electric charge to generate an image signal. The camera signal processing unit 103 is functionally operable to perform predetermined signal processing on an image signal to output digital image data.

The compression/decompression circuit 104 is functionally operable to compress digital image data, for example, according to the MPEG2 technique, and generate compressed video data. Further, if compressed video data is input, the compression/decompression circuit 104 is functionally operable to decompress the video data.

In this case, according to the Moving Pictures Expert Group (MPEG)-2 video compression technique (i.e., according to the moving image compression technique), there are a plurality of types of pictures. More specifically, “I picture” is an intra-frame coded picture. Further, “P (forward prediction)” picture and “B (bidirectional prediction)” picture are inter-frame coded pictures. If the picture type is “I picture” (i.e., the intra-frame coded picture), it is feasible to perform decoding processing based on only the data of the frame and perform a playback operation based on the decoded data.

Further, according to the MPEG-2 technique, playback time information, which is generally referred to as Presentation Time Stamp (PTS), is used to indicate time at which to start a playback operation. When PTS information is allocated to each frame, the time at which to play back each frame may be controlled in a playback operation based on the allocated PTS.

The compression/decompression circuit 104 has the capability of storing the data and information in such a way as to let the microcomputer 107 read out at least PTS information of the “I picture” and the information usable to identify the position of compressed video data in a compression operation. When the compression/decompression circuit 104 stores the above-described information, the microcomputer 107 may search the position of an arbitrary “I picture” in the compressed video data and may play back the arbitrary “I picture.”

The face detection processing unit 120 is functionally operable to receive digital image data and detect a face (i.e., an object) from a captured image corresponding to the input digital image data. The face detection processing unit 120 may hold face detection information.

The face detection information includes face detection information to be displayed, including coordinate information and size information for enabling at least recognizing the position and the size of each face, and face detection information to be recorded that is used to construct face index information.

Further, the face detection processing unit 120 is functionally operable to determine (identify) a main object among detected faces with reference to the size and the position of each face. The main object is determined as the most important object (i.e., a target object) in a single frame and, for example, shooting conditions are adjusted according to the determined main object.

In the present exemplary embodiment, the main object determined by the face detection processing unit 120 is a face of the most important person in the scene. However, any other object, if it is detectable, maybe determined as a main object. For example, an animal such as a dog or a cat (or the face of an animal) may be determined as a main object. Further, a high-contrast object may be determined as a main object.

It is useful to accept a user operation that designates a specific face as a main object in a shooting operation and to determine the designated face as the main object. In the following description, the face designated as the main object is referred to as a “main face.”

The microcomputer 107 may successively read out the face detection information from the face detection processing unit 120 on a frame-by-frame basis. The microcomputer 107 may control various operations to be performed by the imaging apparatus.

The flash ROM 108 stores a program and various parameters that may be executed and processed by the microcomputer 107. The memory 109 is a volatile memory that may be used as a work memory for the microcomputer 107 or the compression/decompression circuit 104. The HDD 112 is a recording medium that may store compressed video data generated by the compression/decompression circuit 104 according to a predetermined format, such as a file allocation table (FAT) file system or any other computer compatible system.

The OSD unit 105 may superimpose various information (e.g., setting menus, title, time, etc) on digital image data. The liquid crystal panel 106 may receive an output of the OSD unit 105 and may display an image according to the output of the OSD unit 105. The operation switch group 111 allows users to input an operation.

Further, the operation switch group 111 includes a mode selection switch that allows users to select one of a camera mode, a playback mode, and a power-off mode. The camera mode is mainly selectable to perform a camera shooting operation. The playback mode is mainly selectable to perform a playback operation. The power-off mode is selectable to turn off a power source.

Further, although not illustrated in the drawing, it is useful to provide a microphone unit, a speaker, or an external output path for audio data and to compress and decompress the audio data together with the image data. The audio data may be multiplexed together with the above-described compressed video data.

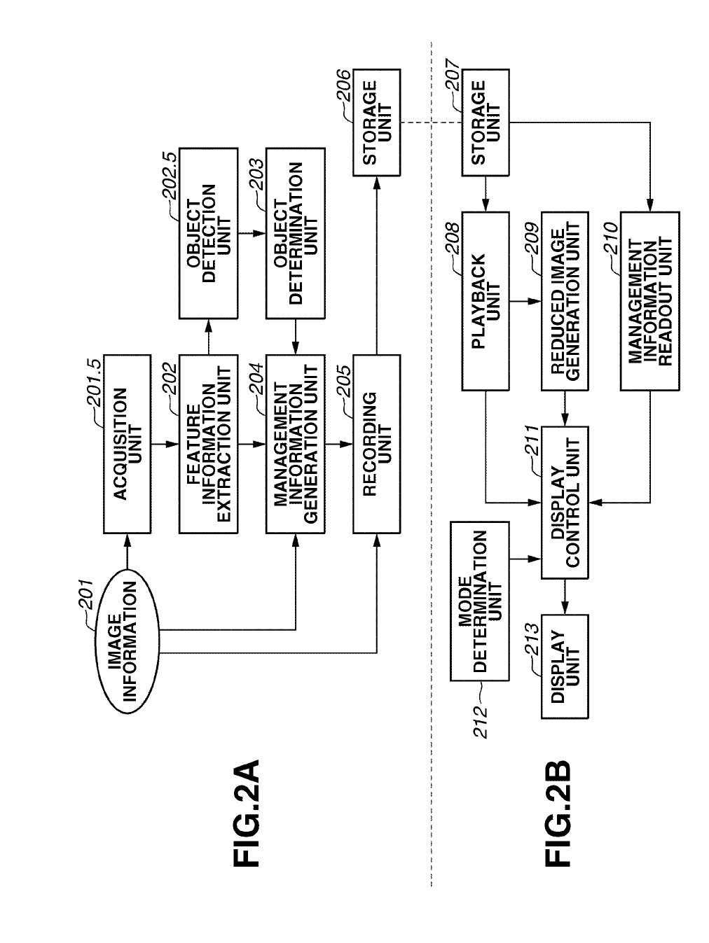

FIGS. 2A and 2B cooperatively illustrate a block diagram of an example functional configuration of the moving image playback apparatus and the moving image management apparatus that may be realized by the above-described imaging apparatus (i.e., the digital video camera) according to the present exemplary embodiment.

FIG. 2A illustrates an example functional configuration of the moving image management apparatus according to the present exemplary embodiment. FIG. 2B illustrates example functional configuration of the moving image playback apparatus according to the present exemplary embodiment.

The moving image management apparatus, as illustrated in FIG. 2A, includes an acquisition unit 201.5, a feature information extraction unit 202, an object detection unit 202.5, an object determination unit 203, a management information generation unit 204, a recording unit 205, and a storage unit 206. The moving image management apparatus may include more or less than the above components. The feature information extraction unit 202 and the object determination unit 203 may be realized by the face detection processing unit 120. Further, the management information generation unit 204 and the recording unit 205 may be realized when the microcomputer 107 executes a program stored in the flash ROM 108.

The acquisition unit 201.5 may be configured to acquire main object information, which is usable to identify a frame image in which an object determined as a main object has appeared, from a moving image in the image information 201. The acquisition unit 201.5 may acquire information usable to identify a frame image in which a face has been detected. The feature information extraction unit 202 may be configured to extract, based on the acquired main object information, frame images in which the main object is present from sequential sections in which the object determined as the main object is the same and the main object is continuously present in the moving image. The feature information extraction unit 202 may be functionally operable to detect a predetermined feature from image information (digital image data) 201 and is functionally operable to generate feature information representing the detected feature. The object detection unit 202.5 may be configured to analyze the moving image to detect a specific object (e.g., a face of a person). The object determination unit 203 may be configured to determine whether to designate the object detected by the object detection unit 202.5 as the main object based on a specific condition. The object determination unit 203 may be functionally operable to determine an object based on the feature information generated by the feature information extraction unit 202. For example, the object determination unit 203 determines a main object from the feature information generated by the feature information extraction unit 202 and generates main object information based on a determination result.

The management information generation unit 204 is functionally operable to receive the image information 201 and the feature information generated by the feature information extraction unit 202. Further, the management information generation unit 204 is functionally operable to receive the determination result (including main object information) from the object determination unit 203. Moreover, the management information generation unit 204 is functionally operable to generate management information, which is used to manage the image information 201, based on the received information.

When the feature information generated by the feature information extraction unit 202 is combined with the main object information generated by the object determination unit 203, information corresponding to the above-described face detection information (i.e., the face detection information to be displayed and the face detection information to be recorded) may be obtained.

Further, the management information includes time information relating to a frame of the image information in which an object appears, main object information indicating whether the frame is a frame in which the main object appears, and a search table that stores information used to identify data of a frame corresponding the time information.

The recording unit 205 is functionally operable to record the image information 201 and the management information relating to the image information 201, which has been generated by the management information generation unit 204, in the storage unit 206. The storage unit 206 is, for example, the hard disk (HDD) 112. However, the storage unit 206 is not limited to the HDD 112. For example, the storage unit 206 may be a memory card or a detachable recording medium (e.g., a compact disc (CD) or a digital versatile disc (DVD)).

The moving image playback apparatus, as illustrated in FIG. 2B, includes a storage unit 207, a playback unit 208, a reduced image generation unit 209, a management information readout unit 210, a display control unit 211, a mode determination unit 212, and a display unit 213. The moving image playback apparatus may include more or less than the above components. For example, it may include some or all of the components of the image management apparatus shown in FIG. 2A.

The playback unit 208, the reduced image generation unit 209, the management information readout unit 210, and the mode determination unit 212 are functional units that may be realized by the microcomputer 107 when the microcomputer 107 executes a program stored in the flash ROM 108. Further, the display control unit 211 maybe realized when the microcomputer 107 executes programs stored in the OSD unit 105 and the flash ROM 108. The display unit 213 may be realized by the liquid crystal panel 106.

The storage unit 207 stores image information together with management information relating to the image information. For example, when the moving image playback apparatus and the moving image management apparatus are integrated as a single apparatus (e.g., an image recording playback system), or when it is a detachable recording medium, the storage unit 207 and the storage unit 206 may be the same storage unit. Further, the system may be modified to read out data from the storage unit 206 and supply the readout data, via a transmission path, to store the data in the storage unit 207.

The playback unit 208 is functionally operable to read the image information stored in the storage unit 207 and play back the readout image information. The reduced image generation unit 209 is functionally operable to reduce the size of a playback image played back by the playback unit 208 to generate a reduced image.

The reduced image generated by the reduced image generation unit 209 may be used, for example, in a thumbnail display operation. The management information readout unit 210 is functionally operable to read the image information together with management information out of the storage unit 207 and supply the readout information to the display control unit 211.

The display control unit 211 is functionally operable to cause the display unit 213 to display the playback image played back by the playback unit 208 or the reduced image generated by the reduced image generation unit 209 based on an output of the mode determination unit 212 and the management information supplied from the management information readout unit 210.

For example, if the output of the mode determination unit 212 is an ordinary playback instruction, the display control unit 211 causes the display unit 213 to display the playback image played back by the playback unit 208. Further, if the output of the mode determination unit 212 is the time line display instruction (display mode), the display control unit 211 causes the display unit 213 to display the reduced image supplied from the reduced image generation unit 209 based on the received management information.

For example, if a first display mode is selected to perform a main face time line display, the display control unit 211 causes the display unit 213 to display images of frames in which the main object appears, side by side, based on the time information and the main object information of each frame in which the object appears, which are included in the management information.

Further, if a second display mode is selected to perform a face time line display, the display control unit 211 causes the display unit 213 to display images of frames indicated by time information, side by side, based on the time information of each frame in which the object appears, which is included in the management information.

Further, if a third display mode is selected to perform the time line display of images selected at designated time intervals, the display control unit 211 searches for data of respective frames selected at the designated time intervals from the image information and causes the display unit 213 to display searched images side by side. An example time line display operation that may realize the face time line display and the main face time line display is described in detail below.

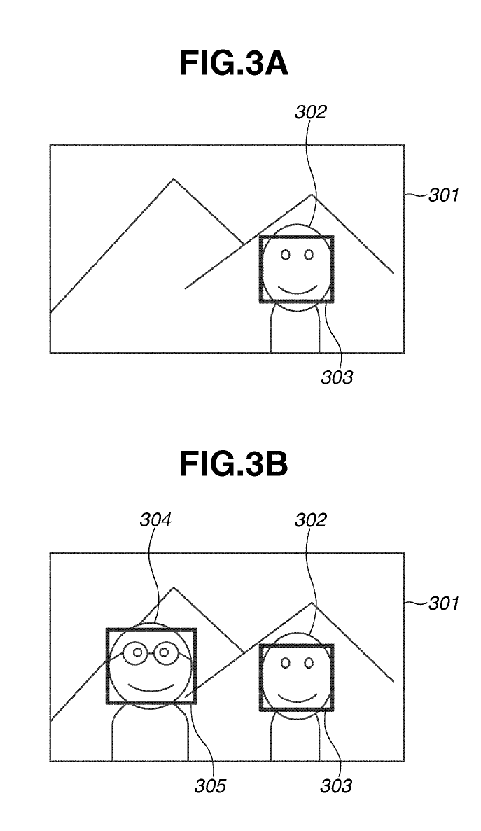

Next, an example of the face detection processing according to the present exemplary embodiment is described in detail below with reference to FIGS. 3A and 3B. FIGS. 3A and 3B illustrate display examples of the liquid crystal panel 106 in a shooting operation.

As illustrated in FIGS. 3A and 3B, the liquid crystal panel 106 has a display area 301 in which a captured image including a person 302 is displayed. A face detection frame 303 is a bitmap image superimposed on a detected face of the person 302. The microcomputer 107 controls the OSD unit 105 to display the above-described bitmap image on a display unit (e.g., the liquid crystal panel 106).

FIG. 3B illustrates another image including two persons, which has been captured after a significant time has elapsed. Compared to the state illustrated in FIG. 3A, a new person 304 is included together with a face detection frame 305 superimposed on a detected face of the person 304. According to the example case illustrated in FIG. 3B, it may be determined that two persons are present in the same frame.

Even in a case where a person has moved between adjacent frames of a captured image during a shooting operation, if the movement of the person is limited within a predetermined short range, it may be determined that the person remains the same between these frames.

The imaging apparatus may determine the similarity of a person continuously appearing in consecutive frames of a captured image by checking the positional relationship (i.e., similarity) between adjacent frame images and, additionally, checking the color (or another image matching) or the size.

The imaging apparatus according to the present exemplary embodiment may detect a plurality of persons that are present in the same frame. Further, the imaging apparatus may determine the same person (face) with reference to the continuity between adjacent frames. Further, in a case where two or more persons are simultaneously present in the same frame, the imaging apparatus identifies a person (or a face) that serves as a main object. The imaging apparatus determines the main object with reference to information (e.g., the position, the size, and the focus position) of each object.

In the present exemplary embodiment, to realize a graphic user interface (GUI), the imaging apparatus detects a frame in which a new face has appeared and records information that is usable to search for the detected frame in a playback operation. Further, the imaging apparatus further records information that is usable to determine whether the frame in which the new face has appeared is a frame in which the main face has newly appeared.

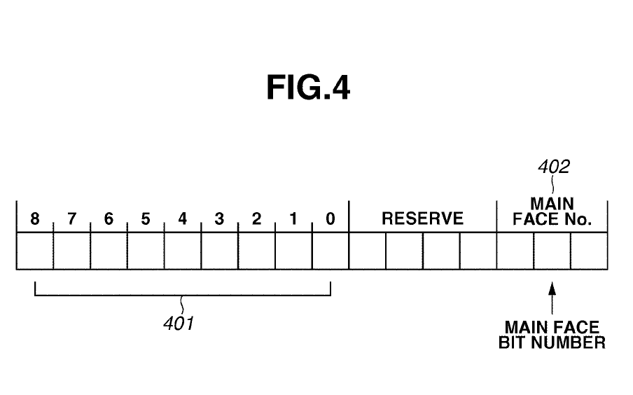

FIG. 4 illustrates an example data configuration of face detection information to be recorded, which is send from the face detection processing unit 120 to the microcomputer 107. The face detection processing unit 120 generates the face detection information to be recorded for each frame. In FIG. 4, one segment corresponds to one bit. More specifically, the face detection information illustrated in FIG. 4 is 16-bit data.

The face detection information illustrated in FIG. 4 includes a field 401 in which a face detection flag may be stored. The serial numbers “0” to “8” attached to eight segments in the “face detection flag” field 401 are face detection bit numbers, which are uniquely allocated to identify each bit in the field 401. In the following description, “Bit 0”, “Bit 1”, . . . , and Bit 8 represent respective bits each having the corresponding face detection bit number.

The face detection flag allocates a detection of one face to one bit. If the bit value is “0”, there is not any face. If the bit value is “1”, one face is present. According to the example illustrated in FIG. 4, the detection states of nine faces may be simultaneously stored. A main face bit number is stored in a field 402. In the field 402 in which the main face bit number is stored, the number identifying the face detection bit serving as the main face, which is one of the face detection bits stored in the “face detection flag” field 401, is stored.

The face detection information to be recorded may be used to indicate an increment in the number of faces, for example, when the value of the face detection bit is changed from “0” to “1.” Further, for example, when the face detection information to be recorded includes a main face bit number “0”, the main face is an object to which “Bit 0” is allocated.

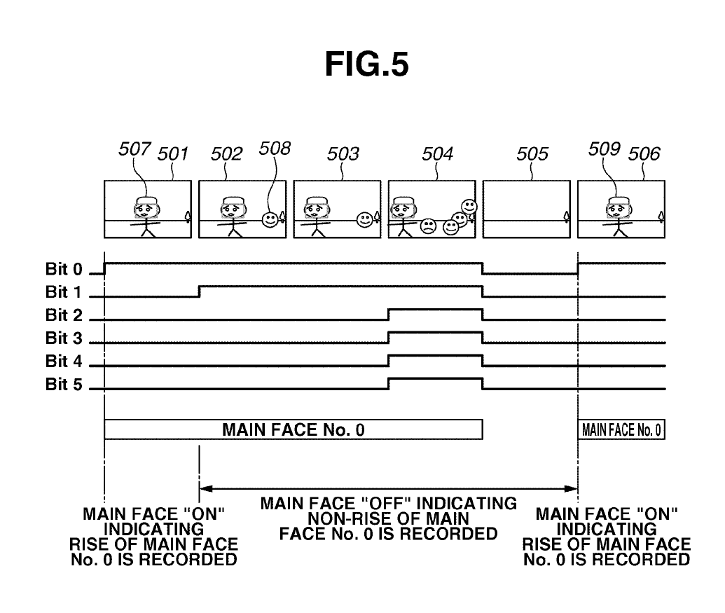

An example change of the face detection information to be recorded in a shooting operation is described in detail below with reference to FIG. 5. The example illustrated in FIG. 5 is composed of six frames 501 to 506 of a captured moving image, in which three faces (i.e., persons) 507 to 509 are detected.

To simplify the following description, only six frames that are selected as representative frames are sequentially disposed at an upper part of FIG. 5. Although not illustrated in the drawing, two or more frames are present between two neighboring frames of the six frames illustrated in FIG. 5.

A lower part of FIG. 5 illustrates changes of six face detection bits “Bit 0” to “Bit 5”, as a part of the face detection flag of face detection information to be recorded, in which each face detection bit takes a value “0” (without face) or “1” (with face).

In the present exemplary embodiment, the face detection bit “Bit 0” in the “face detection flag” field 401 is allocated to the face 507. The face 507 is continuously present in the time duration corresponding to the frames 501 to 504. Therefore, in the above-described time duration, the face detection bit “Bit 0” takes a value “1”.

Another face 508 newly appears at the frame 502. The face detection bit “Bit 1” is allocated to the face 508. The face detection bit “Bit 1” changes its value from “0” to “1”. Similarly, the face detection bit “Bit 2” changes its value from “0” to “1” at the timing corresponding to the frame 504.

Further, in the present exemplary embodiment, in the time duration corresponding to the frames 501 to 504, the microcomputer 107 determines that the face 507 is a main face. Further, as no face (or person) is present in the frame 505 of the image, the microcomputer 107 sets the values of all face detection bits to “0”. If the face 509 appears in the frame 506, the face detection bit “Bit 0” takes the value “1” again. The face detection bit “Bit 0” is stored as the main face bit number in the field 402.

In this case, the face 509 is the first face detected after the timing the values of all face detection bits are once reset to “0”. This is why the face detection bit “Bit 0” is allocated to the face 509. At this timing, it is uncertain whether the face 509 is identical to the face 507. In other words, the face 507 (i.e., the object having been determined as a main face in the former scene) and the face 509 (i.e., the object having been determined as a main face in the latter scene) may be determined as belonging to the same person. On the other hand, the microcomputer 107 may determine that a person of the face 507 is different from a person of the face 509.

In this case, the frame to be recorded as face index information is a frame (i.e., an in-point) in which a face has newly appeared and any one of the face detection bits has changed its value from “0” to “1”.

Further, the microcomputer 107 further records a result of the determination whether the concerned frame is the frame (i.e., the in-point) in which the main face has appeared. According to the example illustrated in FIG. 5, four frames 501, 502, 504, and 506 are the frames in which a new face has appeared. Among these frames, two frames 501 and 506 are the frames in which the main face has appeared.

When information used to search for a frame (i.e., the in-point) in which the face has appeared is recorded with image information, it becomes feasible to perform playback control for displaying reduced images of the frames in which the new face has appeared or performing cueing.

Further, it becomes feasible to display a main face time line of only the frames in which the main face has appeared, in a state where the frame images are reduced and arranged in order of time. The time duration corresponding to the frames 501 to 504 is a section in which a main object (i.e., a main face) is determined as the same object and the main object (i.e., the face 507) is continuously present.

When the main face time line is displayed in the section corresponding to the frames 501 to 504, the microcomputer 107 extracts only the frame image 501 in which the face 507 serving as the main object (i.e., the face to which the face detection bit “Bit 0” is allocated) has appeared as a display target.

The microcomputer 107 does not extract any frame image based on the appearance of objects other than the face 507 serving as the main object (i.e., the faces to which the face detection bits “Bit 1” to “Bit 5” are allocated).

In the time duration corresponding to the frame 506 and subsequent frames, a main object newly appears and continues to be present. Therefore, the microcomputer 107 newly extracts the frame image 506 because the main object is present.

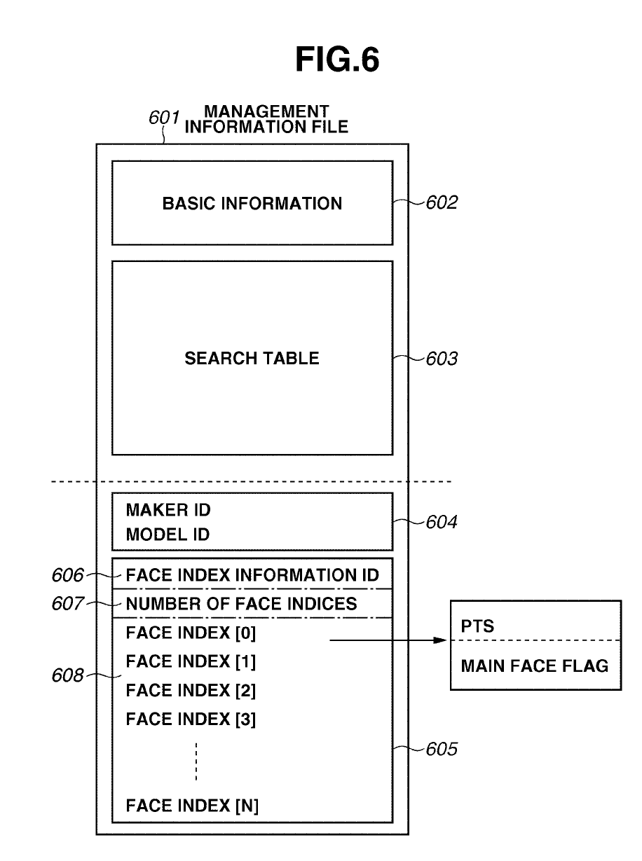

Next, management information including face index information is described in detail below. FIG. 6 illustrates an example of the management information recorded together with compressed video data (i.e., the image information). A management information file 601 includes basic information 602, a search table 603, a model information table 604, and face index information 605.

The basic information 602 includes fundamental information of compressed video data, such as compression method, frame rate, and number of pixels. The search table 603 is required to perform a special playback (e.g., fast-forwarding) or display a frame corresponding to the designated time.

The search table 603 stores ID information of each “I picture” included in a moving image file, PTS information of each “I picture”, positional information indicating the position (e.g., byte number) of each “I picture” from the head of the moving image file, and byte capacity information.

More specifically, the search table 603 stores the information usable to identify frame data corresponding to PTS (i.e., the time information) in the moving image file.

If the moving image file is composed of a plurality of packets, it is useful to record the packet number of each “I picture” together with packet capacity information. When the PTS information of a concerned “I picture” is obtainable from the search table 603, it is feasible to identify the position of the “I picture” in the moving image file.

The model information table 604 is an area where a maker ID and a model ID are recorded. The maker ID is a unique ID allocated to each maker and the model ID is a unique ID allocated to each product.

The face index information 605 includes face index information ID 606, number of face indices 607, and each face index 608. The face index information ID 606 is an identifier indicating that the concerned area is a portion where face index information is recorded. If the moving image playback apparatus may recognize the identifier, the moving image playback apparatus may use the area information as face index information and may realize the face time line display.

On the other hand, if the moving image playback apparatus cannot identify the face index information ID 606 (if the moving image playback apparatus does not know that the identifier indicates the recording portion of the face index information), the moving image playback apparatus cannot use the face index information 605.

The number of face indices 607 is the total number of face indices recorded in the face index 608. In the present exemplary embodiment, the maximum number of face indices recordable in the face index 608 is N. N is an arbitrary number that may be determined beforehand. Limiting the total number of face indices recordable in the face index 608 is effective to prevent the face information from abnormally increasing in view of securing a sufficient amount of available work memory capacity or obtaining satisfactory search speed.

Each face index 608 is constituted by information usable to identify an image (or a frame) to be displayed in the face time line display (e.g., PTS, frame number, etc.) and a main face flag. The main face flag is the main object information that may be used to determine whether the frame relating to each face index 608 is a frame in which the main face has newly appeared. If the main face flag is “0”, the concerned frame does not include any main face. If the main face flag is “1”, the concerned frame includes the main face.

The management information file and the corresponding moving image file are provided as different files. For example, a portion preceding the extension of a file name of the management information file is equalized with a portion preceding the extension of a file name of the corresponding moving image file, so that the management information file may be correlated with the moving image file.

It is also useful to add the content of the management information file as header information of the moving image file, instead of providing the management information file and the moving image file independently.

Next, example processing that may be executed by the microcomputer 107 to construct the face index information to be recorded as part of the management information in a recording operation of compressed video data is described in detail below.

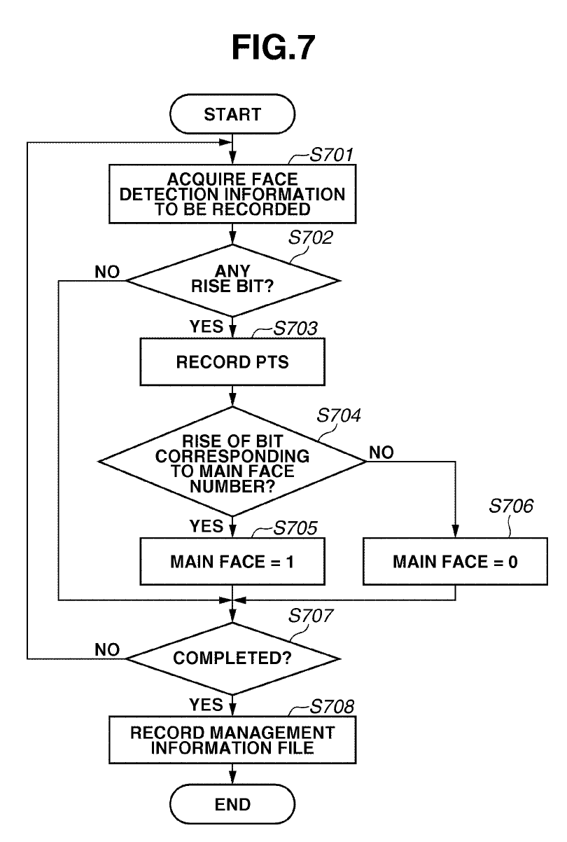

FIG. 7 is a flowchart illustrating an example of constructive processing of face index information according to an exemplary embodiment. To realize the processing illustrated in FIG. 7, the microcomputer 107 executes a program loaded into the memory 109 from the flash ROM 108.

The microcomputer 107 performs the processing illustrated in FIG. 7, while the image sensor 102 performs a shooting operation for acquiring a moving image. However, the processing illustrated in FIG. 7 may be performed by the face detection processing unit 120 that analyzes a moving image already stored in the HDD 112 when the moving image is played back.

Accordingly, it is feasible to allocate new face index information to a moving image if no face index information is allocated to the moving image. Alternatively, it is feasible to update the face index information if already allocated to a moving image.

Upon starting the shooting operation for capturing a moving image (or upon starting the processing for analyzing an already stored moving image), the microcomputer 107 starts the processing illustrated in FIG. 7.

First, in operation S701, the microcomputer 107 acquires face detection information to be recorded for the first frame from the face detection processing unit 120.

In operation S702, the microcomputer 107 refers to the face detection information stored in the “face detection flag” field 401, which has been acquired in operation S701, and determines whether there is any face detection bit that has risen.

In the present exemplary embodiment, the microcomputer 107 determines that the face detection bit has risen when a bit value “0” in the previously acquired face detection information for recording has changed to a bit value “1” in the presently acquired face detection information for recording.

When the microcomputer 107 processes the first frame, there is not any previously acquired face detection information for recording. In this case, if the presently acquired face detection information for recording has a face detection bit value “1” in the “face detection flag” field 401, the microcomputer 107 determines that there is a face detection bit that has risen.

If it is determined that there is a face detection bit that has risen (YES in operation S702), the processing proceeds to operation S703.

In operation S703, the microcomputer 107 records PTS of a frame corresponding to the presently acquired face detection information for recording in the memory 109. If it is determined that there is not any face detection bit that has risen (NO in operation S702), the processing proceeds to operation S707.

In operation S704, the microcomputer 107 refers to the main face bit number in the field 402 of the presently acquired face detection information to be recorded and determines whether there is any face detection bit that has risen. If it is determined that there is a face detection bit that has risen (YES in operation S704), the processing proceeds to operation S705.

In operation S705, the microcomputer 107 records “1” as main face flag information in association with PTS information of the presently processed frame, which has been recorded in the memory 109 in operation S703. On the other hand, if it is determined that there is not any face detection bit that has risen (NO in operation S704), the processing proceeds to operation S706.

In operation S706, the microcomputer 107 records “0” as main face flag information in association with the PTS information of the presently processed frame, which has been recorded in the memory 109 in operation S703.

In operation S707, the microcomputer 107 determines whether the shooting operation of the moving image has been finished and the processing for the final frame has been completed (or determines whether the processing for the final frame of a recorded moving image has been completed).

If it is determined that the processing for the final frame has not been completed (NO in operation S707), the processing returns to operation S701. The microcomputer 107 acquires face detection information to be recorded for the next frame from the face detection processing unit 120 and repeats the above-described processing for the next frame. On the other hand, if it is determined that the processing for the final frame has been completed (YES in operation S707), the processing proceeds to operation S708.

In operation S708, the microcomputer 107 records the management information file in the HDD 112. In the recording of the management information file, the microcomputer 107 sets the PTS information recorded in the memory 109 and its main face flag information (the main object information) as each face index 608, and sets the number of PTSs recorded in the memory 109 as the number of face indices 607, and further allocates a face index information ID. If the recording of the management information file is completed, the microcomputer 107 terminates the processing of the flowchart illustrated in FIG. 7.

The PTS information and the main face flag information are temporarily stored for each frame in the memory 109 if the processing of the final frame is not completed, although the method for storing PTS and the main face flag information is not limited to a specific one and may be adequately modified.

For example, before the processing of the final frame is completed, the microcomputer 107 may successively record the PTS information and the main face flag information for each frame, as part of a management information file, in the HDD 112. Then, in operation S708, the microcomputer 107 may close the management information file.

Through the above-described sequential processing, the microcomputer 107 may construct face index information that is usable to identify the temporal position where a face has appeared and determine whether the position where each face has appeared is the position where a main face has newly appeared.

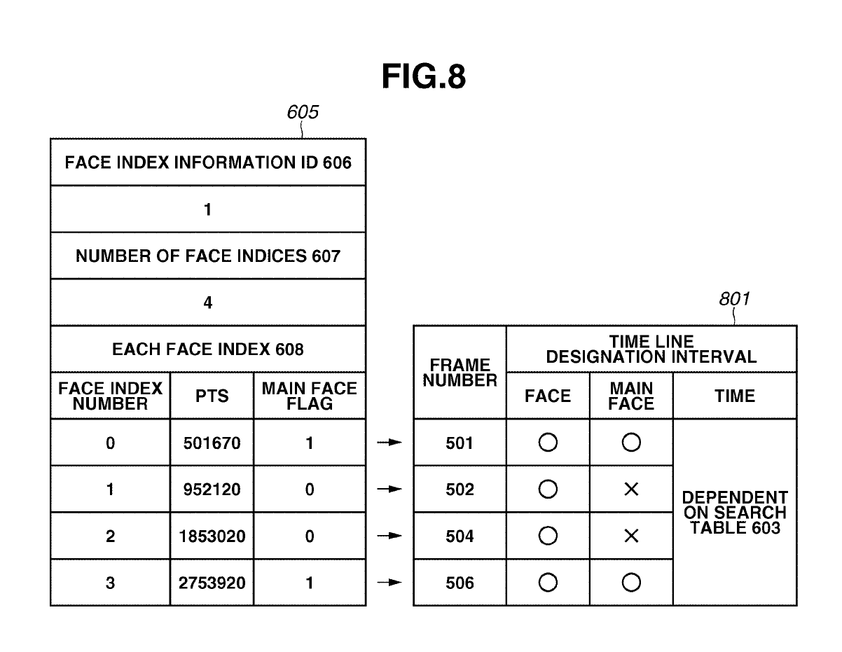

FIG. 8 illustrates an example of the face index information that may be constructed when the shooting example illustrated in FIG. 5 is recorded. As described above, the face index information 605 illustrated in FIG. 8 includes the face index information ID 606, the number of face indices 607, and each face index 608.

According to the example illustrated in FIG. 8, the number of face indices 607 is 4, which indicates the presence of four face indices. Each face index 608 is composed of face index number, PTS, and main face flag.

The information recorded in the face index information 605 is the one having been obtained in the shooting operation of the example illustrated in FIG. 5. Therefore, PTS information in each face index 608 corresponds to the frames 501, 502, 504, and 506 illustrated in FIG. 5. For example, a PTS value “501670” of the face index number 0 corresponds to the frame 501.

Further, the frame 501 is the frame (i.e., the in-point) in which the main face has appeared. Therefore, the main face flag of the frame 501 is set to “1”. As illustrated in FIG. 8, information about other face indices (see 608) is stored similarly. The number of faces increases in respective frames 502 and 504. However, each of the frames 502 and 504 is not the frame in which a main face has newly appeared. Therefore, the main face flag of these frames 502 and 504 is set to “0”.

Further, a table 801 illustrates which frame images are to be displayed in each time line based on the face index information 605. In the table 801, a frame suffixed with “o” is a frame to be displayed. A frame suffixed with “x” is a frame that is not displayed. All frames in the face index 608 are the frames in which a face has newly appeared. Therefore, if the designation interval of the time line is “face”, the moving image playback apparatus displays all of the frames 501, 502, 504, and 506.

Further, if the time line designation interval is “main face”, the moving image playback apparatus displays only the frames in which a main face has newly appeared. Therefore, in the present exemplary embodiment, the moving image playback apparatus displays only the frames 501 and 506 because their main face flags are “1”.

If the time line designation interval is “time”, the moving image playback apparatus determines frames to be displayed with reference to the search table 603 included in the management information file 601, without referring to the face index information 605, because it is unnecessary to check the appearance of a new face.

The imaging apparatus (i.e., the digital video camera) according to the present exemplary embodiment may realize the time line display in the playback mode using the management information file described above. Namely, the imaging apparatus performs display control as described below.

If the operation switch group 111 is operated to instruct the time line display in the playback mode, the imaging apparatus searches for a moving image file as a target of the time line display together with a corresponding management information file.

Then, the imaging apparatus performs a control operation in such a way as to realize the time line display based on the search table 603 and the face index information 605 included in the searched management information file.

Next, an example GUI (i.e., a display example) that may be realized using the face index information of the management information file is described in detail below. In the following description, example processing for playing back a moving image (i.e., a recorded scene) recorded in the shooting example illustrated in FIG. 5 is described in detail below.

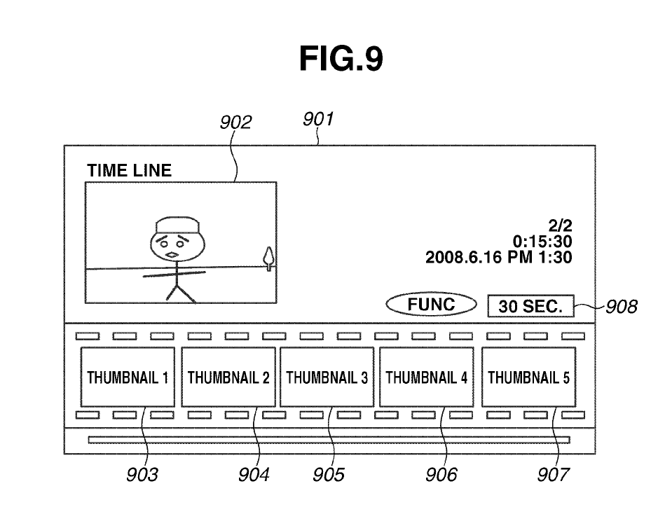

FIG. 9 illustrates an example of the GUI (for the time line display), which is provided to improve the searchability of a scene in a playback operation of a moving image. The time line display generally includes setting an arbitrary scene as a target and displaying a representative image of the target together with a plurality of frame images at predetermined designation intervals. Employing the time line display is useful to identify a scene included in a moving image and search for a desired position in the moving image.

The example GUI illustrated in FIG. 9 includes a display image 901 as an example in the time line display. First, a screen configuration of the GUI is described in detail below with reference to the display image 901. The display image 901 includes a representative image 902 of the entire scene, which is, for example, a reduced image of the “I picture” positioned at the head of the scene.

The representative image 902 may be an image in which the face information has first appeared. Sequentially disposed images 903, 904, 905, 906, and 907 are thumbnail images, which are reduced images generated based on images of the frames disposed at the predetermined designation intervals. The display image 901 further includes a designation interval display field 908, in which a presently selected designation interval may be displayed.

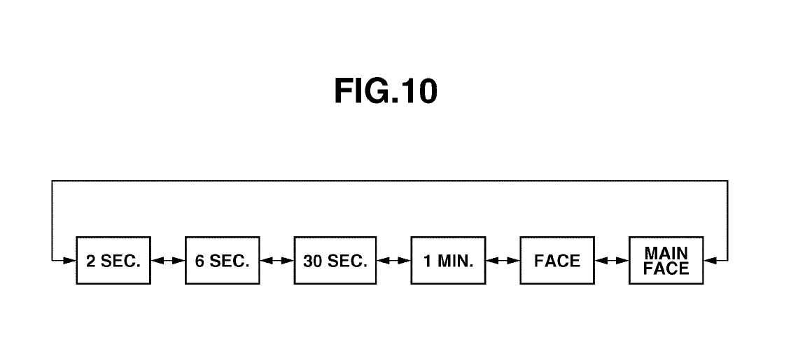

In the present exemplary embodiment, an example selection of the designation interval for the time line display is described below with reference to FIG. 10. FIG. 10 illustrates an example list of selectable designation intervals. If a user performs a predetermined operation on the operation switch group 111, the designation interval is switchable, for example, in the order of 2 sec.→6 sec.→30 sec.→1 min.→face→main face.

The content displayed in the designation interval display field 908 varies according to the selection if made by the user, to let the user confirm the presently selected interval.

For example, the user may adjust the position of a selection frame to the designation interval display field 908 with a direction button included in the operation switch group 111, and may press a selection button included in the operation switch group 111 to toggle in the order of 2 sec.→6 sec.→30 sec.→1 min.→face→main face and select a desired one of the designation intervals.

Further, for example, it is useful to display a pull-down menu including selectable items (e.g., 2 sec., 6 sec., 30 sec., 1 min., face, and main face) when the designation interval display field 908 is selected, to let the user select a desired designation interval.

For example, if the selected designation interval is 30 sec., the imaging apparatus displays thumbnail images of the frame images picked up at the intervals of 30 sec. The microcomputer 107 searches for the positions of these frames in the moving image file with reference to the search table 603. The microcomputer 107 reads searched frame data from a recording medium, and plays back the readout data to realize the thumbnail display operation.

Further, it is feasible to switch the display content according to a user operation from the presently displayed images (i.e., five thumbnail images) to other images (e.g., five frame images preceding or succeeding the presently displayed images).

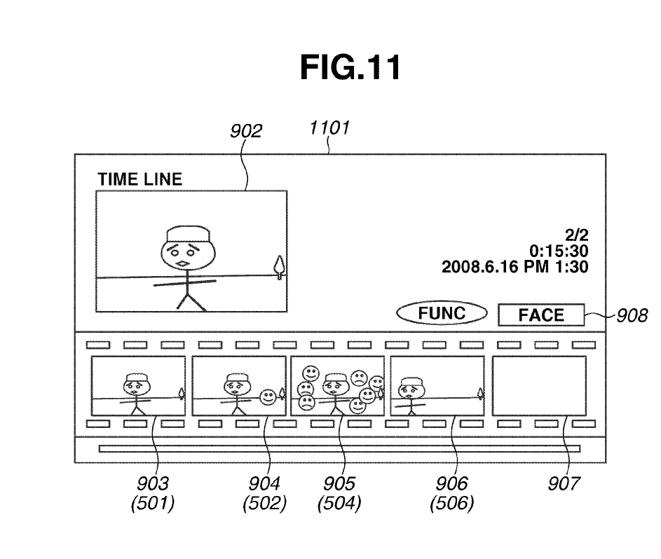

FIG. 11 illustrates an example of the face time line display. The example GUI illustrated in FIG. 11 includes a display image 1101 as an example in the face time line display. The face time line display is a display mode that may be designated when the selected designation interval is “face.”

The microcomputer 107 displays the frames indicated by the PTS information in the face index 608 with reference to the above-described face index information. In the face time line display, the microcomputer 107 displays thumbnail images of the in-point frames in which a face has been newly detected. Accordingly, it is useful to select the face time line display when a user wants to search for a scene including at least one person.

According to the example processing for playing back the moving image including the shooting example illustrated in FIG. 5, all frames indicated by “o” in the “face” field of the time line designation interval in the table 801 illustrated in FIG. 8 are the targets of the thumbnail display.

More specifically, the frames indicated by the PTS information of the face index numbers 0, 1, 2, and 3 are the targets of the thumbnail display. Therefore, the thumbnail images 903 to 906 correspond to the images of the frames 501, 502, 504, and 506 illustrated in FIG. 5 (i.e., the frames stored in the “frame number” field), respectively. The thumbnail images 903 to 906 indicate all positions where any face has newly appeared. According to the illustrated example, there are only four face indices. Therefore, no thumbnail image is present in the space 907. If five or more face indices are present in a scene, thumbnail images are displayed ordinarily.

However, in a situation where many other persons frequently appear around a main object to be captured as a target, the number of positions where the main object appears is generally smaller than the number of positions where other persons appear (see the frame 504 illustrated in FIG. 5).

Accordingly, even if the designation interval is set to “face”, it may take a significant time until the target position appears. The usability of the imaging apparatus deteriorates. Hence, the imaging apparatus according to the present exemplary embodiment provides “main face” as another selectable designation interval in addition to “face.” The imaging apparatus according to the present exemplary embodiment enables users to switch the display pattern between two or more display modes.

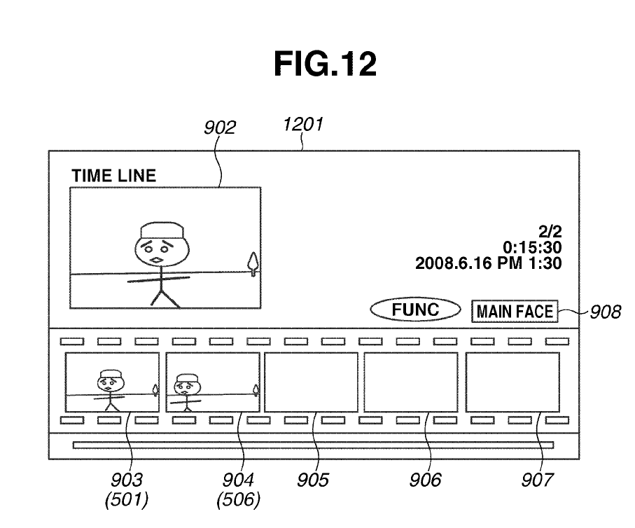

FIG. 12 illustrates an example of a main face time line display. The example GUI illustrated in FIG. 12 includes a display image 1201 as an example in the main face time line display. The main face time line display is a display mode that may be designated when the selected designation interval is “main face.”

The microcomputer 107 displays the frames in which the main face has newly appeared with reference to the main face flag in the above-described face index (i.e., the main object information).

In the main face time line display, the microcomputer 107 excludes the frames 502 and 504 because these frames are not the in-point where the main face has been newly detected, although the thumbnail images of the frames 501, 502, 504, and 506 are displayed in the face time line display illustrated in FIG. 11.

Accordingly, thumbnails to be displayed in the main face time line display are limited to the frames 501 and 506 (i.e., in-points of the main face) as illustrated in FIG. 12.

According to the example processing for playing back a moving image including the shooting example illustrated in FIG. 5, all frames indicated by “o” in the “main face” field of the time line designation interval in the table 801 illustrated in FIG. 8 are the targets of the thumbnail display.

More specifically, the frames indicated by the PTS information of the face index numbers 0 and 3 are the targets of the thumbnail display. The microcomputer 107 realizes the main face time line display by extracting only the face indices whose main face flag is “1” in the “face index 608. According to the illustrated example, there are only two face indices whose main face flag is “1”. Therefore, no thumbnail images are present in the spaces 905, 906, and 907. If three or more face indices whose main face flag is “1” are present in a scene, thumbnail images are displayed in the blank spaces.

It is now assumed that any one of the displayed thumbnail images is selected according to a user operation when the time line designation interval is “main face” or “face.” In this state, if a playback instruction is received from a user, the microcomputer 107 starts a playback operation of the moving image from a frame position indicated by the PTS information of a face index number corresponding to the selected image.

Similarly, when the time line designation interval is “time”, if a playback instruction is received after any one of the displayed thumbnail images is selected, the microcomputer 107 starts a playback operation of the moving image from a frame position indicated by the PTS information of a face index number corresponding to the selected image.

Next, example time line display processing that may be executed by the microcomputer 107 using the above-described management information file in the playback of a moving image is described in detail below.

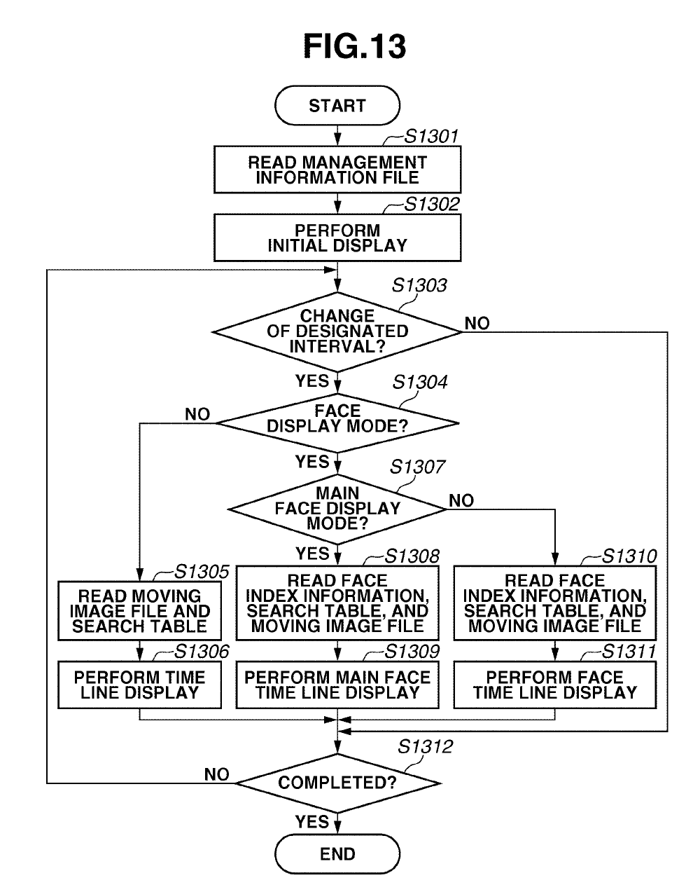

FIG. 13 is a flowchart illustrating an example of the time line display processing. To realize the processing illustrated in FIG. 13, the microcomputer 107 executes a program loaded into the memory 109 from the flash ROM 108.

The microcomputer 107 starts the processing illustrated in FIG. 13 in response to an instruction to start the time line display after a moving image to be subjected to the time line display is selected.

First, in operation S1301, the microcomputer 107 reads (acquires) the management information file of the moving image to be subjected to the time line display.

In operation S1302, the microcomputer 107 performs the time line display at initially set designation intervals based on the management information file acquired in operation S1301 and the moving image file of the moving image to be subjected to the timeline display. An example of the time line screen to be realized in this case is the display screen illustrated in FIG. 9.

In operation S1303, the microcomputer 107 determines whether an instruction to change the designation interval is received from a user. For example, the above-described method is usable as a method for changing the designation interval. If it is determined that the instruction to change the designation interval is received (YES in operation S1303), the processing proceeds to operation S1304. If it is determined that the instruction to change the designation interval is not received (NO in operation S1303), the processing proceeds to operation S1312.

In operation S1304, the microcomputer 107 determines whether the designation interval is changed to “face” or “main face” (or determines whether the designation interval is not changed to “time”). If it is determined that the selected designation interval is neither “face” nor “main face” (or if it is determined that the selected designation interval is “time”) (NO in operation S1304), the processing proceeds to operation S1305.

In operation S1305, the microcomputer 107 reads the search table from the management information file acquired in operation S1301. If the designation interval is neither “face” nor “main face”, it is unnecessary to read the face index information. Therefore, in the present exemplary embodiment, the microcomputer 107 does not read any face index information. Then, the microcomputer 107 acquires images of frames corresponding to the designated time intervals from the moving image file based on the search table.

In operation S1306, the microcomputer 107 performs time line display processing using reduced images of the frames acquired in operation S1305 at the designated time intervals. An example of the time line screen to be displayed in this case is, for example, the display screen illustrated in FIG. 9.

On the other hand, if it is determined that the selected designation interval is “face” or “main face” (or if it is determined that the selected designation interval is not “time”) (YES in operation S1304), the processing proceeds to operation S1307.

In operation S1307, the microcomputer 107 determines whether the selected designation interval is “main face” (or determines whether the selected mode is a main face display mode).

If it is determined that the selected designation interval is “main face” (YES in operation S1307), the processing proceeds to operation S1308. In operation S1308, the microcomputer 107 reads the face index information and the search table from the management information file acquired in operation S1301. Then, the microcomputer 107 acquires images of frames indicated by the PTS information of each face index whose main face flag is “1” in the face index information, from the moving image file, based on the search table.

In operation S1309, the microcomputer 107 performs time line display processing (main face time line display processing) using reduced images of the frames acquired in operation S1308 at the intervals designated for “main face.” An example of the screen to be displayed in this case is, for example, the display screen illustrated in FIG. 12.

On the other hand, if it is determined that the selected designation interval is not “main face” (NO in operation S1307), the processing proceeds to operation S1310.

In operation S1310, the microcomputer 107 reads the face index information and the search table from the management information file acquired in operation S1301. Then, the microcomputer 107 acquires images of frames indicated by the PTS information of each face index in the face index information, from the moving image file, based on the search table.

In operation S1311, the microcomputer 107 performs time line display processing (face time line display processing) using reduced images of the frames acquired in operation S1310 at the intervals designated for “face.” An example of the screen to be displayed in this case is, for example, the display screen illustrated in FIG. 11.

In operation S1312, the microcomputer 107 determines whether the termination of the time line display is instructed based on a user operation or a power source OFF. If the termination of the time line display is not instructed (NO in operation S1312), the processing returns to operation S1303. The microcomputer 107 monitors whether the designation interval has been changed.

On the other hand, if the termination of the timeline display is instructed (YES in operation S1312), the microcomputer 107 terminates the processing of the flowchart illustrated in FIG. 13.

If the imaging apparatus has the capability of enabling each user to designate a main face (i.e., a main object) , it is useful to provide a display mode for displaying only the in-position of the main face designated by the user. Further, even when the number of faces does not change between frames, it is useful to record the position where the main face has been switched as the face index information.

Further, in this case, it is useful to add information to discriminate the main face switched position from the face appearance position. Further, if the imaging apparatus has the capability of enabling each user to register information relating to a specific person and may detect the registered person from an object, it is useful to provide a display mode for displaying only an appearance position where the specific person has been newly detected.

Although the above-described embodiment has been described based on an example moving image, it is useful that the imaging apparatus realizes the time line display including both the face time line display and the main face time line display based on a plurality of still images.

The imaging apparatus according to the present exemplary embodiment may realize the main face time line display with reference to the main face flag (i.e., the main object information) of the face index information and may improve the searchability of a scene in which the main face (i.e., the main object) has appeared.

The above-described display method for disposing a plurality of reduced images in which a face has newly appeared according to the present exemplary embodiment is effectively applicable to a playback of a moving image captured and recorded in a state where a main object is captured together with numerous unspecified objects.

As a modified exemplary of the present invention, a single hardware device is employable to perform control equivalent to that performed by the microcomputer 107 in the above-described exemplary embodiment. Alternatively, if each separated hardware device may be controlled to perform its processing in a decentralized fashion, the overall control may be realized by a plurality of hardware devices.

Further, the example configuration in the above-described exemplary embodiment of the present invention is based on the imaging apparatus (i.e., the digital video camera). However, the present invention is not limited to the above-described example. More specifically, the present invention is applicable to any other apparatuses having a playback function that may control the display of a plurality of image to be displayed simultaneously.

The above-described apparatus is, for example, a personal computer, a personal digital assistant (PDA), a portable telephone, a portable image viewer, a display unit of a printer apparatus that is usable to select and confirm an image to be printed, or a digital photo frame.

Aspects of the present invention may also be realized by a computer of a system or apparatus (or devices such as a CPU or MPU) that reads out and executes a program recorded on a memory device to perform the functions of the above-described embodiment(s), and by a method, the operations of which are performed by a computer of a system or apparatus by, for example, reading out and executing a program stored/recorded on a memory device to perform the functions of the above-described embodiment(s). For this purpose, the program is provided to the computer for example via a network or from a recording medium of various types serving as the memory device (e.g., computer-readable medium).

Disclosed aspects of the embodiments may be realized by an apparatus, a machine, a method, a process, or an article of manufacture that includes a non-transitory storage medium having a program or instructions that, when executed by a machine or a processor, cause the machine or processor to perform operations as described above. The method may be a computerized method to perform the operations with the use of a computer, a machine, a processor, or a programmable device. The operations in the method involve physical objects or entities representing a machine or a particular apparatus (e.g., moving image playback apparatus). In addition, the operations in the method transform the elements or parts from one state to another state. The transformation is particularized and focused on image playback. The transformation provides a different function or use such as extracting frame images, performing control to arrange and display a plurality of the extracted frame images, etc.

In addition, elements of one embodiment may be implemented by hardware, firmware, software or any combination thereof. The term hardware generally refers to an element having a physical structure such as electronic, electromagnetic, optical, electro-optical, mechanical, electro-mechanical parts, etc. A hardware implementation may include analog or digital circuits, devices, processors, applications specific integrated circuits (ASICs), programmable logic devices (PLDs), field programmable gate arrays (FPGAs), or any optical, electromechanical, electromagnetic, or electronic devices. The term software generally refers to a logical structure, a method, a procedure, a program, a routine, a process, an algorithm, a formula, a function, an expression, etc. A software implementation typically includes realizing the above elements (e.g., logical structure, method, procedure, program) as instruction codes and/or data elements embedded in one or more storage devices and executable and/or accessible by a processor, a CPU/MPU, or a programmable device as discussed above. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment may be the code segments to perform the necessary tasks. The software/firmware may include the actual code to carry out the operations described in one embodiment, or code that emulates or simulates the operations.

All or part of an embodiment may be implemented by various means depending on applications according to particular features, functions. These means may include hardware, software, or firmware, or any combination thereof. A hardware, software, or firmware element may have several modules or units coupled to one another. A hardware module/unit is coupled to another module/unit by mechanical, electrical, optical, electromagnetic or any physical connections. A software module/unit is coupled to another module by a function, procedure, method, subprogram, or subroutine call, a jump, a link, a parameter, variable, and argument passing, a function return, etc. A software module/unit is coupled to another module/unit to receive variables, parameters, arguments, pointers, etc. and/or to generate or pass results, updated variables, pointers, etc. A firmware module/unit is coupled to another module/unit by any combination of hardware and software coupling methods above. A hardware, software, or firmware module/unit may be coupled to any one of another hardware, software, or firmware module/unit. A module/unit may also be a software driver or interface to interact with the operating system running on the platform. A module/unit may also be a hardware driver to configure, set up, initialize, send and receive data to and from a hardware device. An apparatus may include any combination of hardware, software, and firmware modules/units.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-227747 filed Oct. 7, 2010, which is hereby incorporated by reference herein in its entirety.

What is claimed is:

1. A moving image playback apparatus comprising:
an acquisition unit configured to acquire main object information, which is usable to identify a frame image in which an object determined as a main object has appeared, from a moving image;
an extraction unit configured to extract, based on the acquired main object information, frame images in which the main object is present from sequential sections in which the object determined as the main object is the same and the main object is continuously present in the moving image; and
a display control unit configured to perform control to arrange and display, in order of time, a plurality of frame images extracted by the extraction unit.

2. The moving image playback apparatus according to claim 1, wherein the extraction unit is configured to extract no frame image based on an object other than the main object in the sequential sections in which the object determined as the main object is the same and the main object is continuously present.

3. The moving image playback apparatus according to claim 1, wherein the extraction unit is configured to extract one frame image from each section.

4. The moving image playback apparatus according to claim 1, wherein the extraction unit is configured to extract a first frame image from each section.

5. The moving image playback apparatus according to claim 1, wherein, if any one of the plurality of frame images displayed by the display control unit is designated by a user, the moving image playback apparatus plays back the moving image from a position corresponding to the designated frame image.

6. The moving image playback apparatus according to claim 1, wherein the display control unit is configured to perform control to, in a first mode, arrange and display, in order of time, the plurality of frame images extracted by the extraction unit and to, in a second mode, arrange and display, in order of time, a plurality of frame images extracted from the moving image at predetermined time intervals.

7. The moving image playback apparatus according to claim 6, wherein the display control unit is configured to perform control to, in a third mode, arrange and display, in order of time, a plurality of frame images, which are frame images in which respective objects detected from the moving image have appeared, regardless of the presence of the main object.

8. The moving image playback apparatus according to claim 1, wherein the display control unit is configured to perform control to arrange and display, in order of time, the plurality of frame images extracted by the extraction unit together with one representative image that represents the moving image.

9. The moving image playback apparatus according to claim 1, wherein the main object is an object that is identified based on a predetermined condition among at least one object detected from a frame image.

10. The moving image playback apparatus according to claim 9, wherein the predetermined condition is a condition based on at least one of a position and size of the detected object in a frame image.

11. The moving image playback apparatus according to claim 9, wherein the predetermined condition is designated according to a user operation.

12. The moving image playback apparatus according to claim 1, wherein the acquisition unit is further configured to acquire information usable to identify a frame image in which a face has been detected,
wherein the extraction unit is configured to determine whether the frame image in which the face has been detected is a frame image in which a main face has appeared, based on the information acquired by the acquisition unit,
wherein, if it is determined that the frame image in which the face has been detected is the frame image in which the main face has appeared, the extraction unit extracts the frame image in which the face has been detected, and
wherein, if it is determined that the frame image in which the face has been detected is not the frame image in which the main face has appeared, the extraction unit does not extract the frame image in which the face has been detected.

13. The moving image playback apparatus according to claim 1, further comprising:
an object detection unit configured to analyze the moving image to detect a specific object;
a determination unit configured to determine whether to designate the object detected by the object detection unit as the main object based on a specific condition; and
a recording control unit configured to record the main object information as management information of the moving image, in the moving image, based on a detection result obtained by the object detection unit and a determination result obtained by the determination unit.

14. The moving image playback apparatus according to claim 13, wherein the specific object is a face of a person.

15. The moving image playback apparatus according to claim 1, wherein the moving image playback apparatus is an imaging apparatus including an imaging unit.

16. A method for controlling a moving image playback apparatus, the method comprising:
acquiring main object information, which is usable to identify a frame image in which an object determined as a main object has appeared, from a moving image;
extracting, based on the acquired main object information, frame images in which the main object is present from sequential sections in which the object determined as the main object is the same and the main object is continuously present in the moving image; and
performing control to arrange and display, in order of time, a plurality of the extracted frame images.

17. A non-transitory computer-readable storage medium storing a program that, when executed by a computer, causes the computer to perform operations that function as each unit of the moving image playback apparatus, the operations comprising:
acquiring main object information, which is usable to identify a frame image in which an object determined as a main object has appeared, from a moving image;
extracting, based on the acquired main object information, frame images in which the main object is present from sequential sections in which the object determined as the main object is the same and the main object is continuously present in the moving image; and
performing control to arrange and display, in order of time, a plurality of the extracted frame images.

18. A moving image management apparatus comprising:
an object detection unit configured to analyze a moving image to detect a specific object;
a determination unit configured to determine whether to designate the object detected by the object detection unit as a main object based on a specific condition; and
a recording control unit configured to record information usable to identify a frame image in which the main object appears in the moving image, as management information of the moving image, based on a detection result obtained by the object detection unit and a determination result obtained by the determination unit.

19. A method for controlling a moving image management apparatus, the method comprising:
analyzing a moving image to detect a specific object;
determining whether to designate the detected object as a main object based on a specific condition; and
recording information usable to identify a frame image in which the main object appears in the moving image, as management information of the moving image, based on a detection result of the specific object and a determination result relating to the main object.

20. A non-transitory computer-readable storage medium storing a program that, when executed by a computer, causes the computer to perform operations that function as each unit of the moving image management apparatus, the operations comprising:
analyzing a moving image to detect a specific object;
determining whether to designate the detected object as a main object based on a specific condition; and
recording information usable to identify a frame image in which the main object appears in the moving image, as management information of the moving image, based on a detection result of the specific object and a determination result relating to the main object.
